(19) United States
(12) Patent Application Publication
(10) Pub. No.: US 2023/0008187 A1
(43) Pub. Date: Jan. 12, 2023

(54) UNIVERSAL FOOD CONTAINER TRANSPORTATION DEVICE

(71) Applicant: Clarence R. HENDERSON, Peninsula, OH (US)

(72) Inventor: Clarence R. HENDERSON, Peninsula, OH (US)

(21) Appl. No.: 17/583,181

(22) Filed: Jan. 24, 2022

Related U.S. Application Data
(60) Provisional application No. 63/140,650, filed on Jan. 22, 2021.

(51) Int. Cl. B60N 3/10; B60R 11/00

(52) U.S. Cl. CPC B60N 3/103; B60R 11/00; B60R 2011/0077; B60R 2011/0071

(57) ABSTRACT

A device for transporting a food container, the device having a frame with a first end and a second end, wherein the first end and the second end are configured to be fastened together by at least one fastener located thereon; an interior side and an exterior side; and a top surface and a bottom surface; and wherein a plurality of tabs extend from the exterior side.

### CROSS REFERENCE TO RELATED APPLICATIONS

This application claims priority to U.S. Provisional Patent Application No. 63/140,650, filed on Jan. 22, 2021, entitled “UNIVERSAL FOOD CONTAINER TRANSPORTATION DEVICE,” which is hereby incorporated by reference herein.

### TECHNICAL FIELD

The disclosed technology relates generally to a device for transporting a food container, and in particular, but not exclusively to, a universal device and method for transporting a food container having any shape.

### BACKGROUND

It is often that someone prepares a home-made dish or other prepared food in order to take it to an event or gathering. In such instances, the person will be required to transport the dish after it has been cooked and/or prepared. Most often, such transportation occurs by transporting the entire food container by way of a vehicle. However, transporting the dish presents certain challenges.

Often prepared dishes are hot, and are unable to be simply held in a driver's or passenger's lap in order to not scald or burn the person carrying or holding the dish. Alternatively, other dishes contain liquids, such as in a soup or chili, of which are easily displaced from a container if not adequately secured.

Therefore, it is often required to place the prepared dish or container on a vehicle floor, trunk, or seat during transport. However, it is desirable that this is achieved without spillage and/or without ruining the composition of the dish, which often occurs during driving, since the dish is able to easily slide or move about during transport when simply placed on a surface within a vehicle.

Additionally, it is generally known that there are a plethora of container shapes used for preparing food and/or carrying prepared food. For example, a soup pot and a rectangular baking dish have very different dimensions. As such, it if often required that a person obtain a specific carrying device or jacket that is specifically intended to be paired with a specific container in order to adequately transport the dish. However, even with a specific carrying device, the prepared dish can easily shift and move about during transport, thus spilling or ruining the dish prior to arrival at the desired destination.

Therefore, certain improvements are desired for transporting any type or any shape of food container to help ensure the container does not slide, flip, shift or otherwise move during transport.

### BRIEF SUMMARY

In some aspects, a device for transporting a food includes a frame extending from a first end to a second end. The frame includes an interior side and an exterior side. The frame also includes a top surface and a bottom surface. A plurality of tabs extend from the exterior side, and the first end and the second end are configured to be fastened together by at least one fastener located thereon.

In some aspects, a method for transporting a food container includes providing a container, the container having an outer periphery. The method also includes encompassing the outer periphery of the container with a frame. The frame includes a first end and a second end. The first end and the second end are configured to be fastened together by a fastening mechanism located thereon. The frame also includes a plurality of tabs. The method further includes fastening the fastening mechanism such that the frame is adjacent to the outer periphery of the container. The method still further includes affixing the plurality of tabs to an interior surface of a vehicle to immobilize the container during transport.

In some aspects, a device for transporting a food container includes a pliable frame extending from a first end to a second end. The frame includes an exterior side, an interior side opposing the exterior side, a top surface, and a bottom surface opposing the top surface. The frame further includes a tab extending away from the exterior side, the tab configured to releasably secure the frame to an associated interior surface of a vehicle. The frame is configured to be elastically deformable to receive a portion of the food container such that the frame is in contact with a portion of the perimeter of the food container to limit motion of the food container relative to the associated interior surface of the vehicle.

### BRIEF DESCRIPTION OF THE FIGURES

These and other features of the disclosed technology, and the advantages, are illustrated specifically in embodiments now to be described, by way of example, with reference to the accompanying diagrammatic drawings, in which:

FIG. 1 is a side isometric view of an illustrative embodiment of the disclosed technology;

FIG. 2 is a cross-sectional view taken along the line 1-1 of an illustrative embodiment of the disclosed technology;

FIG. 3 is a side isometric view of an illustrative embodiment of the disclosed technology;

FIG. 4 is an isometric view of a frame receiving a food container;

FIG. 5 is a flowchart illustrating an exemplary method of an illustrative embodiment of the disclosed technology.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawings and description are to be regarded as illustrative in nature and not as restrictive.

### DETAILED DESCRIPTION

The following terms are used throughout the description, the definitions of which are provided herein to assist in understanding various aspects of the subject disclosure.

As used herein the terms “container”, “food container”, and “dish” are used interchangeably, and refer to most any type of hot food container or cold food container, or most any other type of container used for or with prepared food such as, but not limited to, a container made of metal, glass, aluminum, microwave plastics, or any other suitable material, and may comprise a pot, pan, bowl, or the like. The container may have any shape or configuration, and therefore may include, but is not limited to, a round container, a square container, rectangular container, an oval container, other polygonal-shaped container, or the like.

As used herein, the term “vehicle” should be understood to include, but is not limited to, a car, a truck, an SUV, a boat, an airplane, or other motor vehicle, whether used for personal or commercial purposes.

The disclosed technology generally described hereinafter provides for a universal device for transporting a food container. In contrast to other conventional containers, which often require a specific carrying device to be specifically paired with a container for transport, the disclosed universal device is able to completely surround and take the shape of a food container having any shape in order to immobilize and/or secure the container during transport. Since the disclosed device is able to be used with a container of any shape, the need to purchase or obtain a specific apparatus/accessory to be paired with a certain type of dish (e.g., food container) is eliminated.

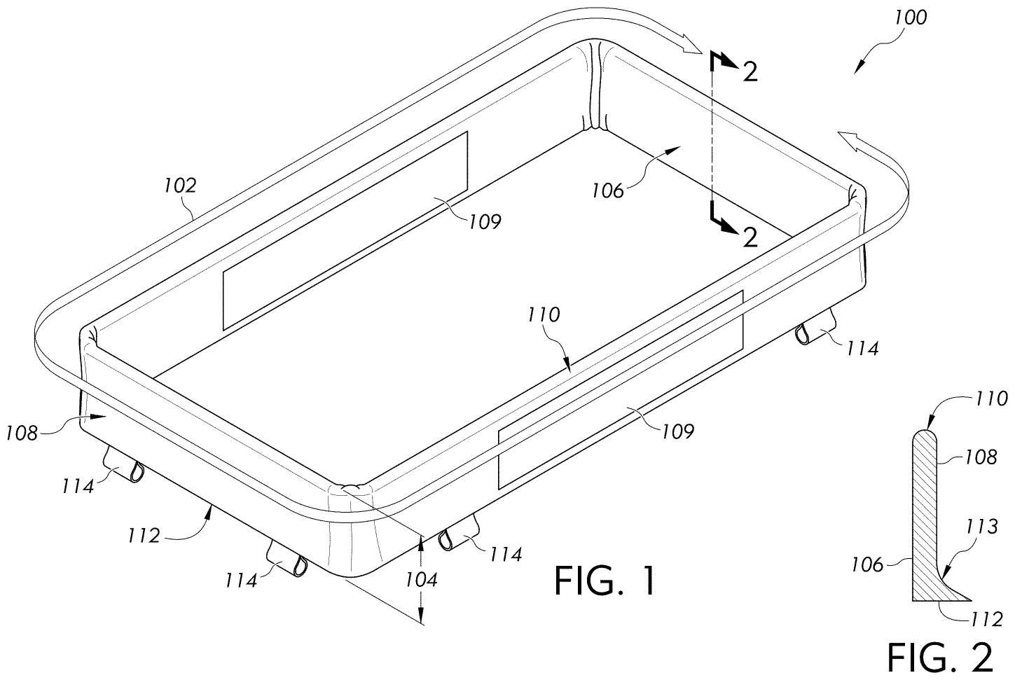

With reference to FIG. 1, the disclosed device comprises a frame 100. The frame 100 is configured to completely surround the perimeter or periphery of any food container (not shown in FIG. 1) shape to ensure that the container is immobilized and/or secured during transport. In order to be universally used with any shaped container, the frame 100 is pliable. The pliability of the frame allows for the frame to be molded and secured around the container, such that the frame takes the shape of and is adjacent to the outer periphery of the container, notwithstanding the container shape. For example, the frame 100 can mold around the circular base of a stock pot or soup pot, while also being able to mold around a rectangular glass or ceramic baking dish.

As shown in FIG. 1, the frame 100 comprises a loop-like length of material formed or constructed as a single, unitary piece; the length shown as dimension 102. The frame 100 is comprised of a band or belt of flexible material. In some examples, the material comprises nylon, linen-rayon, a woven or non-woven fabric, such as, but not limited to, cotton or polyester combinations, canvas, any other suitable type of fabric material, or the like. In some embodiments, the material is insulated, water repellant, stain resistant, and/or washable.

The frame 100 further includes an interior side 106 and an exterior side 108. When in use, at least a portion of the interior side 106 of the frame will be directly adjacent to the outer periphery of the desired container that is to be transported. In some embodiments, the interior side 106 comprises an insulated layer 109 to help keep a dish hot, or alternatively, cold while being transported. In other examples, the insulated layer 109 can be located on the exterior side 108 of the frame 100. It is to be understood that the insulated layer 109 can be flexible such that it is able to move, flex, stretch, etc. with the frame 100 as it is placed around the dish or food container. For the purposes of the description of the insulated layer 109, the interior side 106 can include all of the surface within the frame 100 facing the food container. The exterior side 108 can include all of the opposing surfaces to the interior side 106. For example, the exterior side 108 can include all of the surfaces that are not typically in contact with the dish or food container and may be facing away from the dish or food container.

The frame 100 further comprises a top surface 110 and a bottom surface 112. When in use, the bottom surface 112 will be directly adjacent to an interior surface of a vehicle. In some examples, the top surface 110 and the bottom surface 112 are of substantially equal width and substantially equal length. For the purposes of this disclosure, substantially equal can mean that the compared dimensions are equal to or less than ¼-inch difference.

In some examples, the frame 100 is at least 15 inches in length, in other embodiments, at least 30 inches in length, and in other embodiments, at least 40 inches in length. In other examples, the frame 100 is less than 100 inches in length, in other embodiments, less than 60 inches in length, and in other embodiments, less than 45 inches in length. However, it is to be understood that these dimensions are merely exemplary and are not meant to be limiting.

It is to be appreciated that the frame 100 can be scaled to nearly any dimension. Additionally, many different frames 100 can be designed and manufactured to meet a broad range of applications. For example, one particular size of frame 100 may be used to transport a relatively large buffet dish while another particular size of frame 100 may be used to transport a casserole dish that may be relatively small in comparison to the buffet dish.

It is also to be appreciated that a width 104 of the frame 100 can be designed to work appropriately with the food container that is desired to be secured to the interior surface of the vehicle. In some examples, the width 104 can be relatively short compared to a top-to-bottom measurement of the food container. In some examples, the width 104 can be longer than the top-to-bottom measurement of the food container such that a portion of the frame 100 can simply be folded over at least a portion of the food container to help insulate the food container and/or limit spills onto the interior surface of the vehicle.

In some examples, as shown in FIG. 2, the width of the top surface 110 is less than (i.e., narrower than) the width of the bottom surface 112. In some examples, the frame 100 includes a tapered base 113. In such examples, the tapered base 113 provides additional support to the frame when placed on an interior vehicle surface in order to ensure the container does not move, slide, tip-over, flip, etc. relative to the interior vehicle surface during transportation. In some examples, the tapered base 113 extends away from the food container (e.g., away from the

[symbol]

With reference to FIG. 1, the frame 100 can include a plurality of tabs 114. Specifically, the tabs 114 are configured to releasably adhere to the interior surface of a vehicle. The plurality of tabs 114 extend outwardly from the frame 100, wherein each tab 114 contains an adhering face (not shown in FIG. 1). The adhering face allows each tab to be releasably adhered to an interior surface of a vehicle to immobilize a food container during transport.

For example, the interior surface of a vehicle may include, but is not limited to, the fabric or surface of the trunk floor, the fabric or surface of an interior floor mat, or other interior fabric surface. When in use, the frame 100 is secured and/or fastened around a container, and the plurality of tabs 114 are affixed or positively adhered to an interior surface of a vehicle. The plurality of tabs 114 provide an additional measure of stabilizing the container during transport.

In some embodiments, the tabs 114 extend outwardly and are attached to the exterior side 108. In other embodiments, the tabs 114 extend outwardly and are attached to the bottom surface 112.

In some examples, the frame comprises at least 4 tabs 114, in other examples, at least 8 tabs 114, and in other examples, at least 10 tabs. In some examples, the frame comprises less than 20 tabs, and in other examples, less than 15 tabs 114.

In some examples, the plurality of tabs 114 are comprised of the hook-side of the hook-and-loop (i.e., Velcro®) type fastener. It should be understood that the tabs can be made of any material that will releasably adhere the tabs 114 to an interior surface of a vehicle in order to immobilize the frame 100 during transport, and therefore, prevent the container from any movement during transportation, yet still be able to be removed after transport.

Any suitable form or mechanism for adherence can be applied to the adhering face. For example, a hook-and-loop fastener can be used to releasably adhere the tab 114 to the interior surface of the vehicle. In other examples, the adhering face can be constructed of, coated with, etc. a material (e.g., rubber or rubber-like material) having a relatively large coefficient of kinetic friction when placed on a rubber or plastic floor mat of a vehicle. In some examples, the tab 114 can have an adhering face on both sides of a tab 114 with differing adherence structures on each side such that a user can choose to use the hook-and-loop fastener side or the rubber side to help secure the frame 100 to the interior surface of the vehicle. In such examples, the tabs 114 can be flexible or elastic-like such that the tabs 114 can be rotated, turned, etc. relative to the frame 100.

In yet further examples, the tabs 114 can be rigid and extend into slots defined by the interior surface of a vehicle. Of course, the frame 100 and the tabs 114 may also cooperate with an intermediate plate or object provided between the interior surface of the vehicle and the frame 100. The intermediate plate or other object may serve to further secure the frame 100 to the interior surface of the vehicle.

Further, in some embodiments, the plurality of tabs 114 allow for the frame 100 to be easily and compactly stored. When the frame is not in use, the frame 100 can be rolled up and/or compactly stored, where the plurality of tabs may be used to keep the frame 100 in a storage configuration. For example, the tabs 114 located on the first end 300 can interact with the tabs 114 located on the second end 302 to hold the frame 100 in a rolled or folded orientation.

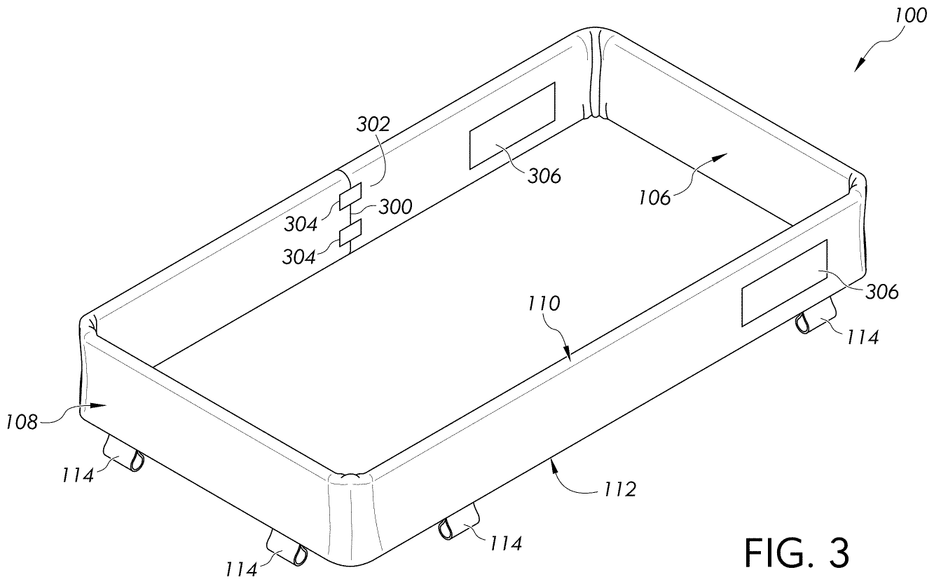

As shown in FIG. 3, in further examples, the frame 100 can extend from a first end 300 and a second end 302. The first end 300 and the second end 302 are individual ends of the belt-like frame configured to be fastened together by a fastener, plurality of fasteners, or a fastening mechanism 304, in order for the frame 100 to be closely-fitted or tightly-fitted about (i.e., directly adjacent to) the outer perimeter of a dish or container. When not actively fastened together, the first end 300 and the second end 302 can be disconnected in order to remove the container from the frame 100 when not in active transport.

It should be understood that most any type of fastener 304 or fastening mechanism can be used, such that the fastener 304 is able to securely fasten the first end 300 and the seconds end 302 together to firmly secure the frame 100 around the container. In some examples, the fastener 304 or plurality of fasteners comprise a cinch-strap, a release buckle, a snap fastener (e.g., press stud), or any other fastener that is able to be quickly released when not in use.

In some examples, the fastener 304 is a hook-and-loop (e.g., Velcro®) fastener. In such examples, the hook-side of the hook-and-loop fastener is located on the first end 300 and the pile-side is located on the second end 302, or vice versa.

As with the previously described examples, the frame 100 is comprised of a flexible material. In some examples, the material comprises nylon, linen-rayon, a woven or non-woven fabric, such as, but not limited to, cotton or polyester combinations, canvas, any other suitable type of fabric material, or the like. In some examples, the material is insulated, water repellant, stain resistant, and/or washable.

In any of the described examples, the frame 100 can be include weighted material 306. Inclusion of weighted material can provide additional reinforcement to stabilize the dish or container and can provide a robust structure to help ensure the dish or container is unable to slide or move relative to a surface within the vehicle during transportation. In some examples, the weighted material 306 can include, but is not limited to, a granular material (such as sand), rice, pellets, or the like. It should be understood that any such weighted material is appropriate as long as the material has a mass greater than that of the frame material alone. In some examples, the weighted material 306 can be located within the frame 100 (e.g., between the interior side 106 and the exterior side 108). In other examples, the weighted material 306 can be located on any of the interior side 106, the exterior side 108, the top surface 110, the bottom surface 112, or any combination thereof.

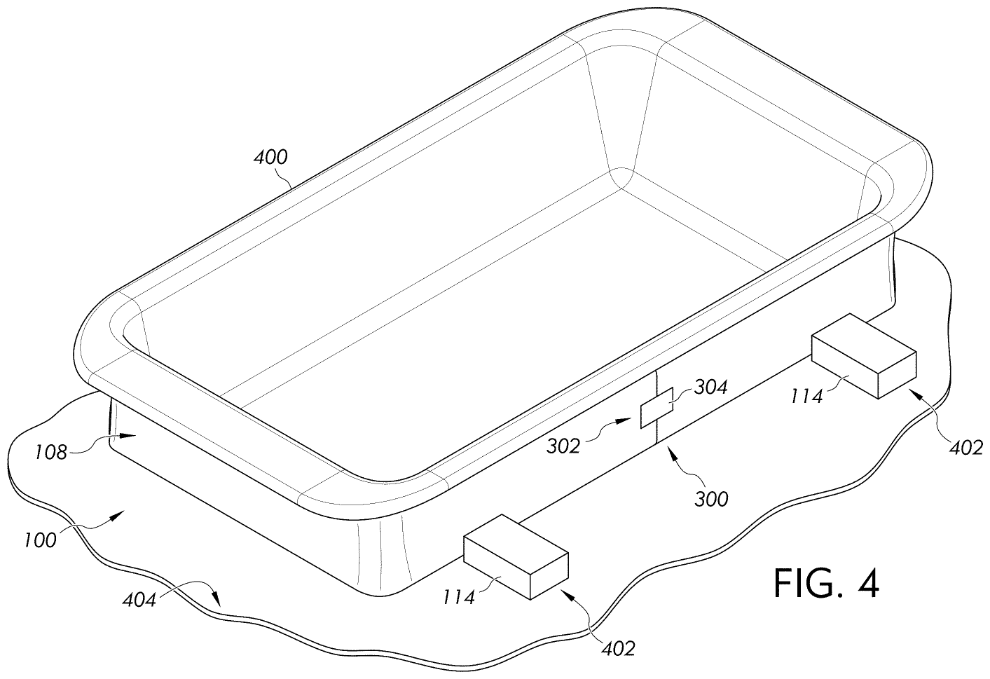

As shown in FIG. 4 and as previously described, the frame 100 can be flexible to surround or partially surround a portion of a dish or container 400. In some examples, the frame 100 can be contiguous to the container 400 for the entire perimeter around the base of the container 400. In other examples, there can be portions of the frame 100 that do not touch portions of the perimeter of the container 400. For example, a container 400 may include or define recesses into which the frame 100 will not reach, as it is typically being stretched around the exterior perimeter of the container 400.

The frame 100 is shown surrounding and gripping the container 400 with the first end 300 attached to the second end 302 with the use of the fastener 304. The tabs 114 are extending away from the frame 100. Only two tabs 114 are shown, however, it is to be understood that any number of additional tabs 114 may be present. Each tab 114 includes an adhering face 402 having an adhering structure (not shown) to releasably secure the frame 100 to the interior surface 404 of the vehicle.

In yet another aspect of the present technology, a method 500 for transporting a food container is provided. The method 500 allows for a user to transport a container with most any type of shape through the use of a universal frame, where the frame allows for the frame to be molded and secured around the container, such that the frame takes the shape of and is adjacent to the container to ensure the container does not move relative to the interior surface of the vehicle during transportation. As such, the frame 100 can firmly grip a portion of the exterior of the container 400 to act like a belt. As described, in some examples, the belt-like frame 100 can have a unitary construction, and in other examples, the belt-like frame 100 can be a length of material having a first end 300 and a second end 302 that are fastened together to grip the container 400. While the disclosure describes the frame 100 as a belt, it is also contemplated that the frame 100 may have a pliable panel extending between the sides of the belt to make a tray-like device that can be stretched about or fitted to a container 400.

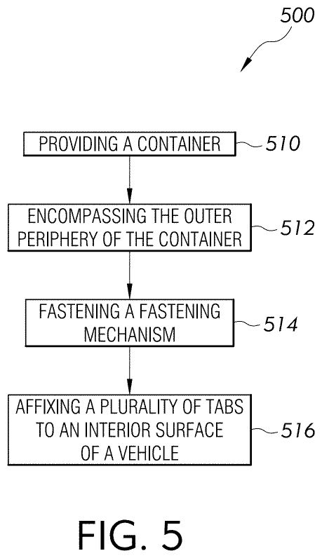

As shown in FIG. 5, the method 500 includes providing a container (step 510). The container comprises an outer periphery or outer perimeter, where the outer periphery or outer perimeter can be of any shape. In some examples, the container comprises a round, square, rectangular, oval, or other polygonal shaped periphery.

The method further provides for encompassing or surrounding the outer periphery of the container (step 512) with a frame. In some examples, the frame comprises a first end and a second end, wherein the first end and the second end are configured to be fastened together by a fastening mechanism located thereon, and a plurality of tabs.

The method further provides for fastening the fastening mechanism (step 514). The fastening mechanism assures that when in use, the frame is directly adjacent to the outer periphery of the container. It should be understood that any suitable type of fastening mechanism can be employed, so long as the container can be easily fastened prior to transport and easily unfastened to remove the container. In some examples, the fastening mechanism comprises a cinch-strap, a release buckle, a snap fastener, a press stud, or hook-and-loop fastener.

The method further provides for affixing a plurality of tabs (step 516) to an interior surface of a vehicle to immobilize the container during transport. The step of affixing or adhering a plurality of tabs (step 216) provides for a user to pull, stretch and/or extend each tab outwardly from the outer surface of the frame, such that each tab is taut, to positively adhere the tabs to an interior surface of a vehicle.

In some embodiments, the plurality of tabs are comprised of hook-and-loop fasteners. In some examples, the interior surface of a vehicle comprises a trunk floor, an interior floor mat, or other interior fabric surface.

The devices and methods of the present disclosure provide for a device for transporting a food container. The device comprises a frame having: a first end and a second end, wherein the first end and the second end are configured to be fastened together by at least one fastener located thereon, an interior side and an exterior side, and a top surface and a bottom surface; and wherein a plurality of tabs extend from the exterior side, each tab comprising a hook-and-loop fastener, and wherein the frame is at least at least 30 inches in length.

While embodiments of the disclosed technology have been described, it should be understood that the present disclosure is not so limited, and modifications may be made without departing from the disclosed technology. The scope of the disclosed technology is defined by the appended claims, and all devices, processes, and methods that come within the meaning of the claims, either literally or by equivalence, are intended to be embraced therein.

1. A device for transporting a food container, the device comprising:
a frame extending from a first end to a second end, the frame having:
an interior side and an exterior side, and
a top surface and a bottom surface, wherein:
a plurality of tabs extend from the exterior side, and
the first end and the second end are configured to be fastened together by at least one fastener located thereon.

2. The device as recited in claim 1, wherein the frame is pliable.

3. The device as recited in claim 1, wherein the frame comprises a material selected from the group consisting of nylon, a woven fabric, a non-woven fabric, canvas, or a combination thereof.

4. The device as recited in claim 1, wherein the at least one fastener comprises a cinch-strap, a release buckle, a snap fastener, a press stud, or hook-and-loop fastener.

5. The device at recited in claim 1, wherein the frame is weighted.

6. The device as recited in claim 1, wherein the interior side further comprises an insulated material.

7. The device as recited in claim 1, wherein the bottom surface comprises a tapered base.

8. The device as recited in claim 1, wherein the plurality of tabs are configured to be affixed to a surface to immobilize the frame.

9. The device as recited in claim 1, wherein the plurality of tabs are hook-and-loop fasteners.

10. A method for transporting a food container, the method comprising:
(a) providing a container, the container having an outer periphery;
(b) encompassing the outer periphery of the container with a frame, the frame having:
i. a first end and a second end, wherein the first end and the second end are configured to be fastened together by a fastening mechanism located thereon, and
ii. a plurality of tabs;
(c) fastening the fastening mechanism such that the frame is adjacent to the outer periphery of the container; and
(d) affixing the plurality of tabs to an interior surface of a vehicle to immobilize the container during transport.

11. The method as recited in claim 10, wherein the container comprises a round, square, rectangular, oval, or other polygonal shaped periphery.

12. The method as recited in claim 10, wherein the fastening mechanism comprises a cinch-strap, a release buckle, a snap fastener, a press stud, or hook-and-loop fastener.

13. The method as recited in claim 10, wherein the plurality of tabs are comprised of hook-and-loop fasteners.

14. The method as recited in claim 10, wherein the plurality of tabs comprise an adhering face to be releasably adhered to an interior surface of a vehicle.

15. The method as recited in claim 10, wherein the interior surface of a vehicle comprises a trunk floor, an interior floor mat, or other interior fabric surface.

16. A device for transporting a food container, the device comprising:
a pliable frame extending from a first end to a second end, the frame comprising:
an exterior side;
an interior side opposing the exterior side;
a top surface;
a bottom surface opposing the top surface; and
a tab extending away from the exterior side, the tab configured to releasably secure the frame to an associated interior surface of a vehicle, wherein:
the frame is configured to be elastically deformable to receive a portion of the food container such that the frame is in contact with a portion of the perimeter of the food container to limit motion of the food container relative to the associated interior surface of the vehicle.

17. The device as recited in claim 16, wherein the frame comprises a material selected from the group consisting of nylon, a woven fabric, a non-woven fabric, canvas, or a combination thereof.

18. The device as recited in claim 16, wherein the tab comprises an adherence mechanism to releasably adhere the frame to the associated interior surface of the vehicle.

19. The device at recited in claim 16, wherein the frame is weighted.

20. The device as recited in claim 16, wherein the interior side further comprises an insulated material.
